(19) United States
(12) Patent Application Publication
(10) Pub. No.: US 2013/0019711 A1
(43) Pub. Date: Jan. 24, 2013

(54) ENGINE CONTROL DEVICE AND CONTROL METHOD, ENGINE STARTING DEVICE, AND VEHICLE

(71) Applicants: Kouki Moriya, Aichi-gun (JP); Jumpei Kakehi, Toyota-shi (JP); Hasrul Sany Bin Hashim, Toyota-shi (JP)

(72) Inventors: Kouki Moriya, Aichi-gun (JP); Jumpei Kakehi, Toyota-shi (JP); Hasrul Sany Bin Hashim, Toyota-shi (JP)

(73) Assignee: TOYOTA JIDOSHA KABUSHIKI KAISHA, Toyota-shi (JP)

(21) Appl. No.: 13/638,218

(22) PCT Filed: Mar. 15, 2011
(86) PCT No.: PCT/JP2011/056014

§ 371 Date: Sep. 28, 2012

(51) Int. Cl. F02N 15/04; B60W 10/08

(52) U.S. Cl. 74/7 A; 477/3; 180/65.285; 903/902

(57) ABSTRACT

In a vehicle including a starter for starting an engine, capable of controlling an actuator for an engagement operation of a pinion gear and a motor for rotating the pinion gear individually, an ECU drives the actuator when the rotational speed NE of the engine becomes lower than a reference rotational speed NEston, and drives the motor when a predetermined period has elapsed since the driving of the actuator is initiated. When the rotational speed exceeds reference rotational speed again during the predetermined period, the ECU delays the driving of the motor until the rotational speed becomes lower than reference rotational speed again, and a predetermined period has elapsed.

### TECHNICAL FIELD

The present invention relates to an engine control device and control method, an engine starting device, and a vehicle. More particularly, the present invention relates to controlling a starter for an engine that can drive individually an engagement mechanism for engaging a pinion gear with a ring gear of the engine and a motor for rotating the pinion gear.

### BACKGROUND ART

For the purpose of reducing fuel consumption and emissions in vehicles incorporating an internal combustion engine or the like as the engine, some vehicles are mounted with the so-called idling stop or economic running function directed to automatically stopping the engine when the vehicle has stopped and the brake pedal is manipulated by the driver, and automatically starting the engine again in response to a restarting operation made by the driver such as reducing the operated amount of the brake level to zero.

Furthermore, some starters for starting the engine can drive individually the engagement mechanism for engaging the pinion gear of the starter with the ring gear of the engine and a motor for rotating the pinion gear.

EP 2159410 A (PTL 1) discloses a configuration of controlling the starter of an engine that can control individually a pinion gear and a motor for rotating the pinion gear by switching, when the engine is to be restarted after the engine has been stopped, between a mode in which the pinion gear is driven before the motor and a mode in which, previous to the motor, the pinion gear is driven, according to the engine rotational speed.

### CITATION LIST

### PATENT LITERATURE

PTL 1: EP 2159410 A

### SUMMARY OF INVENTION

### Technical Problem

In the event of the engine being stopped by the idling stop or economic running function at the aforementioned vehicle, there may be the case where the engine is restarted when the engine rotational speed is still relatively high. In this case, the starter may be controlled such that the pinion gear is driven in response to the engine rotational speed becoming as low as a predetermined reference rotational speed at which the pinion gear in a non-rotational state is engageable with the ring gear, and the pinion gear is driven by the motor after engagement with the ring gear.

After the engine is stopped, the engine rotational speed will not necessarily fall down smoothly. For example, the rotational speed may become lower while varying in fluctuation due to the pulsation of the piston caused by the air in the cylinder. When this variation is great, there may be the case where the engine rotational speed, once being reduced down to the reference rotational speed, increases again to exceed the reference rotational speed.

In such an event, there is a possibility of the motor being driven under the state where the difference in the rotational speed between the pinion gear and the ring gear is so great that proper engagement therebetween cannot be established. This may become the cause of wear or damage of these gears. There is also the possibility of larger noise caused by the contact between the gears, leading to annoying the user.

In view of the foregoing, an object of the present invention is to allow, when an engine including a starter that can control individually a pinion gear and a motor for driving the pinion gear is to be restarted after being stopped, the pinion gear and the ring gear to be engaged appropriately to restart the engine even in the case where variation in the engine rotational speed is great.

### Solution to Problem

An engine control device of the present invention controls an engine provided with a starter including a second gear engageable with a first gear coupled to a crankshaft, an actuator moving the second gear to a position engaging with the first gear in a driving state, and a motor for rotating the second gear. The actuator and the motor each can be controlled individually. The control device includes a control unit driving the actuator when the engine rotational speed becomes lower than a predetermined first reference rotational speed, and driving the motor after the actuator is driven. When the engine rotational speed exceeds a second reference rotational speed after the actuator is driven, the control unit delays driving of the motor than when the engine rotational speed does not exceed the second reference rotational speed.

When the engine rotational speed exceeds the second reference rotational speed after the actuator is driven, the control unit preferably delays driving of the motor until the engine rotational speed becomes lower than the second reference rotational speed again.

Preferably, the control unit drives the motor when a first period has elapsed since the actuator is driven. When the engine rotational speed exceeds the second reference rotational speed after the actuator is driven and before the first period has elapsed, the control unit drives the motor when a second period has elapsed after the engine rotational speed becomes lower than the second reference rotational speed again.

Preferably, the second period is set shorter than the first period.

Preferably, the second reference rotational speed is set at a value equal to the first reference rotational speed.

Preferably, the second reference rotational speed is set at a value lower than the first reference rotational speed.

An engine starter device of the present invention includes a starter and the control device set forth above.

A vehicle according to the present invention includes an engine, a starter, and a control device. The starter includes a second gear engageable with a first gear coupled to a crankshaft of the engine, an actuator moving the second gear to a position engaging with the first gear in a driving state, and a motor for rotating the second gear. The control device controls the starter such that the actuator is driven when the engine rotational speed becomes lower than a predetermined first reference rotational speed, and the motor is driven when a predetermined period defined in advance has elapsed after the actuator is driven. The actuator and motor each can be controlled individually. When the engine rotational speed exceeds the second reference rotational speed after the actuator is driven, the control device delays driving of the motor than when the engine rotational speed does not exceed the second reference rotational speed.

### Advantageous Effects of Invention

When an engine including a starter that can control individually a pinion gear and a motor for rotating the pinion gear is to be restarted after being stopped, the pinion gear and the ring gear can be engaged appropriately even in the case where variation in the engine rotational speed is great.

### BRIEF DESCRIPTION OF DRAWINGS

FIG. 1 is an entire block diagram of a vehicle incorporating an engine control device according to a first embodiment.

FIG. 2 is a diagram to describe the behavior of the engine rotational speed after stopping the engine.

FIG. 3 is a diagram to describe the outline of starter drive control according to the first embodiment.

FIG. 4 is a functional block diagram to describe starter drive control executed at an ECU according to the first embodiment.

FIG. 5 is a flowchart to describe a starter drive control process executed at the ECU in the first embodiment.

FIG. 6 is a flowchart to describe in detail a pinion starter drive control process of FIG. 5.

FIG. 7 is a flowchart to describe in detail a motor drive determination process of FIG. 5.

FIG. 8 is a flowchart to describe in detail a motor drive control process of FIG. 5.

FIG. 9 is a diagram to describe the outline of starter drive control according to a second embodiment.

FIG. 10 is a flowchart to describe in detail a motor drive determination process according to a modification of the second embodiment.

FIG. 11 is a flowchart to describe in detail a motor drive control process according to a modification of the second embodiment.

### DESCRIPTION OF EMBODIMENTS

Embodiments of the present invention will be described hereinafter with reference to the drawings. In the following description, the same elements have the same reference characters allotted. Their designation and function are also the same. Therefore, detailed description thereof will not be repeated.

### First Embodiment

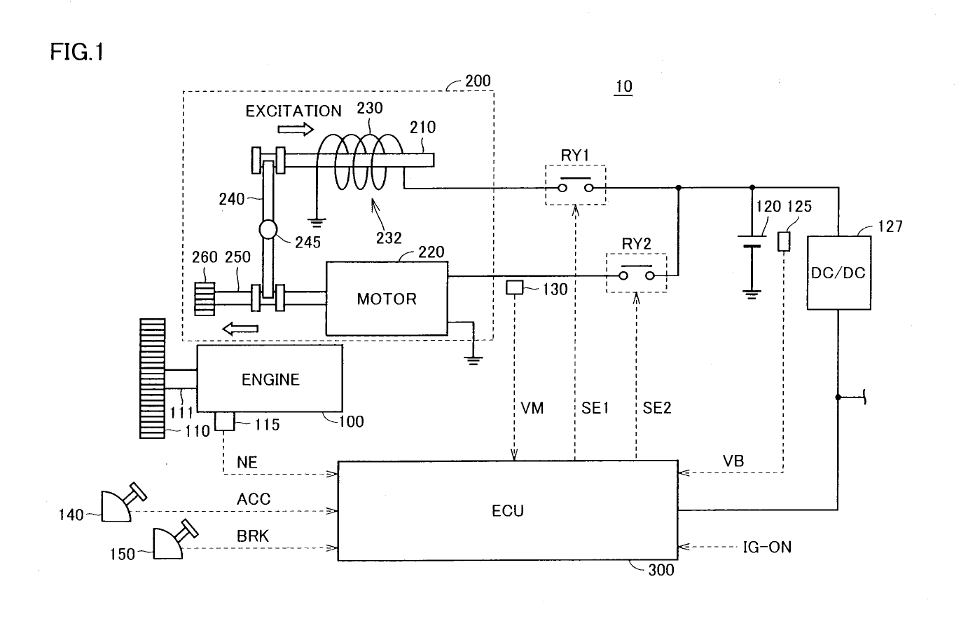

FIG. 1 is an entire block diagram of a vehicle 10 incorporating an engine control device according to the first embodiment. Referring to FIG. 1, vehicle 10 includes an engine 100, a battery 120, a starter 200, a control device (also referred to as an electronic control unit (ECU) hereinafter) 300, and relays RY1 and RY2. Starter 200 includes a plunger 210, a motor 220, a solenoid 230, a connector 240, an output member 250, and a pinion gear 260.

Engine 100 generates a motive force to cause vehicle 10 to run. A crankshaft 111 of engine 100 is connected to a driving wheel via a power transmission device that includes a clutch, a reduction gear, and the like.

A rotational speed sensor 115 is provided at engine 100. Rotational speed sensor 115 detects a rotational speed NE of engine 100 to output the detected result to ECU 300.

Battery 120 is a rechargeable power storage component. Battery 120 is formed of a secondary battery such as a lithium ion battery, a nickel-metal hydride battery, a lead battery, or the like. Battery 120 may be formed of a power storage element such as an electrical double layer capacitor

Battery 120 is connected to starter 200 via relays RY1 and RY2 under control of ECU 300. Battery 120 supplies the power supply voltage for driving to starter 200 by closing relays RY1 and RY2. The negative electrode of battery 120 is connected to body earth.

Battery 120 is provided with a voltage sensor 125. Voltage sensor 125 detects an output voltage VB of battery 120 and outputs the detected value to ECU 300.

The voltage of battery 120 is supplied to ECU 300 as well as to auxiliary equipment such as the inverter of an air conditioner or the like via a DC/DC converter 127.

Relay RY1 has one end connected to the positive electrode of battery 120 and the other end connected to one end of a solenoid 230 in starter 200. Relay RY1 is controlled by a control signal SE1 from ECU 300 to switch between supplying and cutting off the power supply voltage from battery 120 to solenoid 230.

Relay RY2 has one end connected to the positive electrode of battery 120 and the other end connected to motor 220 in starter 200. Relay RY2 is controlled by a control signal SE2 from ECU 300 to switch between supplying and cutting off the power supply voltage to motor 220 from battery 120. A voltage sensor 130 is provided at the power line connecting relay RY2 and motor 220. Voltage sensor 130 detects a motor voltage VM and outputs the detected value to ECU 300.

The supply of the power supply voltage to motor 220 and solenoid 230 in starter 200 can be controlled independently by relays RY1 and RY2.

Output member 250 is coupled with a rotational shaft of a rotor (not shown) in the motor through, for example, a linear spline or the like. Further, pinion gear 260 is provided at an end of output member 250 at the side opposite to motor 220. When the power supply voltage is supplied from battery 120 by closing relay RY2 to cause rotation of motor 220, output member 250 transmits the rotational operation of the rotor to pinion gear 260 for rotation thereof.

As mentioned above, solenoid 230 has one end connected to relay RY1 and the other end connected to the body earth. When relay RY1 is closed to excite solenoid 230, solenoid 280 draws plunger 210 in the direction of the arrow. Namely, plunger 210 and solenoid 230 constitute actuator 232.

Plunger 210 is coupled with output member 250 via connector 240. Solenoid 230 is excited to draw plunger 210 in the direction of the arrow. Accordingly, output member 250 is moved by connector 240 having a fixed fulcrum 245 from the standby position shown in FIG. 1 in the direction opposite to the moving direction of plunger 210, i.e. in the direction of pinion gear 260 moving farther away from the body of motor 220. Plunger 210 is biased by a force in a direction opposite to that of the arrow in FIG. 1 by a spring mechanism not shown, and returns to the standby position when solenoid 230 attains a non-excited state.

By the movement of output member 250 in the axial direction by the excitation of solenoid 230, pinion gear 260 engages with ring gear 110 provided at the outer circumference of a flywheel or drive plate attached to crankshaft 111 of engine 100. By the rotational motion of pinion gear 260 in a state engaged with ring gear 110, engine 100 is cranked up to start engine 100.

According to the first embodiment, an actuator 232 that moves pinion gear 260 to engage with ring gear 110 provided at the outer circumference of a flywheel or drive plate of engine 100 and motor 220 that rotates pinion gear 260 are controlled individually.

Although not shown in FIG. 1, a one-way clutch may be provided between output member 250 and the rotor shaft of motor 220 to prevent the rotor of motor 220 from rotating by the rotational motion of ring gear 110.

Actuator 232 shown in FIG. 1 is not limited to the above-described mechanism as long as the rotation of pinion gear 260 can be transmitted to ring gear 110 and switching is allowed between an engaged state and non-engaged state of pinion gear 260 with ring gear 110. For example, a mechanism may be employed in which engagement between pinion gear 260 and ring gear 110 is established by moving the shaft of output member 250 in the radial direction of pinion gear 260.

Although not shown, ECU 300 includes a CPU (Central Processing Unit), a storage unit, and an input/output buffer to receive the inputs from each sensor and to provide a control command to each device. The control thereof is not limited to processing by software, and a portion thereof may be processed by developing dedicated hardware (electronic circuit).

ECU 300 receives a signal ACC representing the manipulation of an accelerator pedal 140 from a sensor (not shown) provided at accelerator pedal 140. ECU 300 receives a signal BRK representing the manipulation of a brake pedal 150 from a sensor (not shown) provided at brake pedal 150. ECU 300 also receives a start manipulation signal IG-ON by an ignition operation or the like conducted by the driver. ECU 300 generates a start request signal or stop request signal of engine 100 based on such information and outputs control signals SE1 and SE2 according to the generated signal to control the operation of starter 200.

For example, when the stopping condition of the vehicle being stopped and brake pedal 150 being operated by the driver is established, a stop request signal is generated and ECU 300 stops engine 100. In other words, when a stop condition is established, the fuel injection and combustion at engine 100 are stopped.

At a later time, when a starting condition of the manipulation amount of a brake pedal 150 by the driver to attain zero is established, a start request signal is generated and ECU 300 drives motor 220 to start engine 100. Alternatively, engine 100 may be started in response to an operation of accelerator pedal 140, a shift lever to select the transmission range or gear, or a switch to select a vehicle running mode (for example, power mode or economic mode, or the like).

When an idling stop or economic running function is to be implemented in a vehicle including a starter that can drive the engagement mechanism for a pinion gear and a motor for rotating the pinion gear individually, there may be the case where restarting is designated under the state where the engine rotational speed is high. A scheme may be employed in which, at the time of restarting the engine, first the actuator is driven to cause the pinion gear to be engaged with the ring gear of the engine, and then the motor is driven at a timing corresponding to elapse of a predetermined period since the engagement operation command has been output during which the engagement operation should be completed, whereby the crankshaft of the engine is rotated.

At this stage if the engine rotational speed is too high, there may be the case where the pinion gear and the ring gear cannot be engaged appropriately due to a great difference in the speed therebetween. Therefore, when restarting of the engine is designated under a state where the engine rotational speed is high, the engagement operation of the pinion gear is initiated in response to the engine rotational speed becoming lower than a predetermined reference rotational speed.

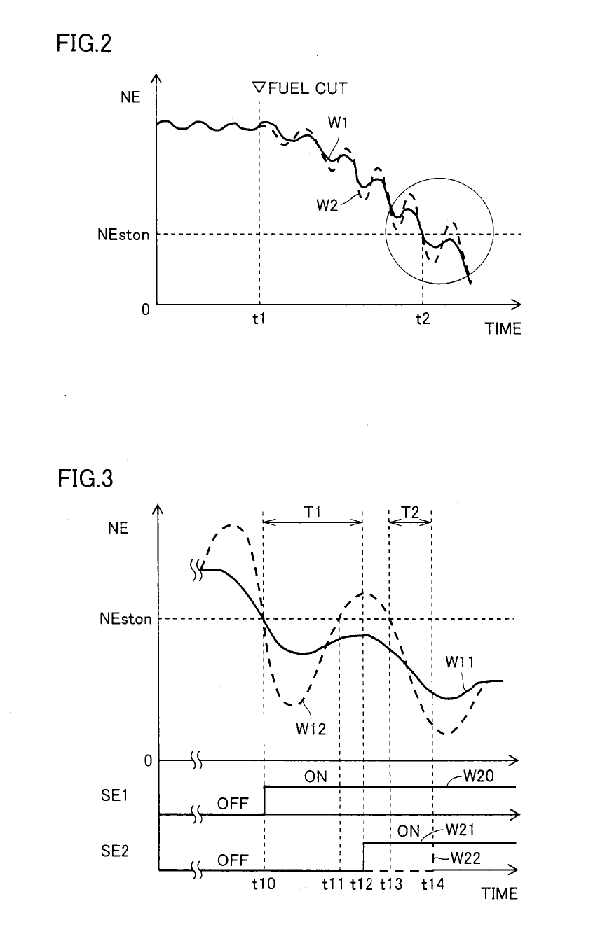

During the reduction of the engine rotational speed in response to the supply of fuel to the engine being stopped, pulsation may occur in the rotation of the crankshaft by the compression/expansion of air in the piston of the engine. The engine rotational speed NE falls while fluctuating, as shown in FIG. 2. This fluctuating variation of the rotational speed is known to have a tendency of greater amplitude as the rotational speed becomes lower.

Referring to FIG. 2, fuel supply is stopped by the fuel cut at time t1 so that engine rotational speed NE is reduced while varying in a fluctuating manner. When the engine rotational speed becomes as low as a reference rotational speed NEston where engagement with the pinion gear is possible, the actuator is activated to initiate the engagement operation of the pinion gear.

At this stage, as indicated by the solid line W1 in FIG. 2, the pinion gear and the ring gear can be engaged appropriately in the case where the amplitude of the fluctuating variation is relatively small and rotational speed NE does not exceed reference rotational speed NEston after time t2. However, as indicated by the broken line W2 in FIG. 2, in the case where the amplitude of the fluctuating variation is relatively great and the rotational speed NE exceeds reference rotational speed NEston after time t2, the pinion gear may not be engaged with the ring gear. In such a case, if the motor is driven at elapse of a predetermined period since the output of the engagement operation command, the pinion gear will rotate in a state still not yet engaged with the ring gear. Accordingly, the wear or damage of the pinion gear and ring gear will be facilitated, and it will cause reducing the durability. Furthermore, there is a possibility of annoying the user by the contacting noise between the pinion gear and ring gear.

In view of such issues, starter drive control is executed according to the first embodiment to delay, when engine rotational speed NE once becomes lower than reference rotational speed NEston and then becomes higher again after the pinion gear engagement operation command has been output, the driving of the motor until engine rotational speed NE becomes lower than reference rotational speed NEston again. Accordingly, the pinion gear and the ring gear can be engaged appropriately, and the durability and quietness of the starter can be improved.

FIG. 3 is a diagram to describe the outline of starter drive control according to the first embodiment, which shows an enlargement of the section indicated around the circle at time t2 in FIG. 2, as well as the state of control signals SE1 and SE2 of relays RY1 and RY2. Lines W11 and W12 representing the state of engine rotational speed NE correspond to the state where an engine restart operation is not carried out.

Referring to FIGS. 1 and 3, in response to the reduction of engine rotational speed NE down to reference rotational speed NEston after stopping the supply of fuel to engine 100, control signal SE1 is turned ON at time t10 to initiate the driving of actuator 232 (curve W20 in FIG. 3).

In the case where engine rotational speed NE does not exceed reference rotational speed NEston after time t10, as shown in line W11, control signal SE2 of relay RY2 to drive motor 220 is turned ON at time t12 corresponding to elapse of a predetermined period T1 during which the engagement operation should be completed (line W21 in FIG. 3). Accordingly, engine 100 is cranked up.

In the case where engine rotational speed NE exceeds reference rotational speed NEston again before the elapse of predetermined period T1 due to the great fluctuating variation (time t11), the driving of motor 220 at time t12 corresponding to the elapse of predetermined period T1 is prohibited. Then, at elapse of a predetermined period T2 (time t14) from time t13 where engine rotational speed NE reaches reference rotational speed NEston again, control signal SE2 of relay RY2 is turned ON, as indicated by broken line W22 in FIG. 3.

Thus, in the case where engine rotational speed NE exceeds reference rotational speed NEston again after once becoming lower than reference rotational speed NEston, the driving timing of motor 220 is delayed until engine rotational speed NE becomes lower than reference rotational speed NEston again in order to prevent pinion gear 260 from rotating under a state where not yet engaged with ring gear 110. Accordingly, wear or damage of pinion gear 260 and ring gear 111 can be suppressed. Moreover, any great contacting noise between pinion gear 260 and ring gear 110 can be suppressed.

Predetermined period T2 after the delaying operation may be set equal to predetermined period T1. However, since pinion gear 260 has already been moved close to ring gear 110 and is rotating by forming contact with ring gear 110 at the point in time t12 in FIG. 3, it is considered that engagement between pinion gear 260 and ring gear 110 can be established promptly when engine rotational speed NE becomes lower than reference rotational speed NEston again. For the purpose of expediting the restarting of engine 100 as much as possible, predetermined period T2 is preferably set shorter than predetermined period T1.

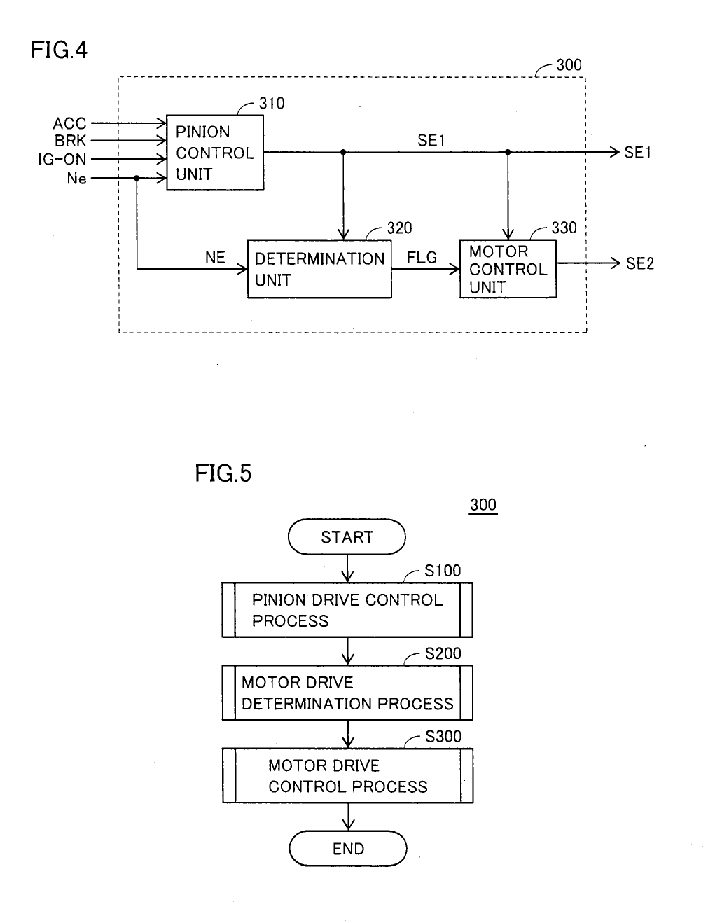

FIG. 4 is a functional block diagram to describe starter drive control executed at ECU 300 according to the first embodiment. Each functional block in FIG. 4 can be implemented by processing in hardware or software through ECU 300.

Referring to FIGS. 1 and 4, ECU 300 includes a pinion control unit 310, a determination unit 320, and a motor control unit 330.

Pinion control unit 310 receives a start manipulation signal IG-ON, manipulation signals ACC and BRK of accelerator pedal 140 and brake pedal 150, respectively, and rotational speed NE of engine 100. When detection is made that a restart request of engine 100 has been issued based on start manipulation signal IG-ON, and manipulation signals ACC and BRK of accelerator pedal 140 and brake pedal 150, respectively, pinion control unit 310 sets control signal SE1 ON for driving actuator 232 when rotational speed NE of engine 100 becomes lower than reference rotational speed NEston.

Determination unit 320 receives rotational speed NE of engine 100 and control signal SE1 of relay RY1 from pinion control unit 310. Determination unit 320 monitors whether rotational speed NE becomes higher than reference rotational speed NEston until elapse of a predetermined period T1 since actuator 232 is driven. When determination unit 320 detects that rotational speed NE exceeds reference rotational speed NEston before elapse of predetermined period T1, a standby flag FLG to delay the drive of motor 220 is turned on and the ON flag is output to motor control unit 330. Standby flag FLG is set OFF when a predetermined period T2 has elapsed since rotational speed NE becomes lower than reference rotational speed NEston again.

Motor control unit 330 receives standby flag FLG from determination unit 320 and control signal SE1 of relay RY1 from pinion control unit 310. When standby flag FLG is still OFF after detection of control signal SE1 being turned ON, motor control unit 330 turns on control signal SE2 of relay RY2 to drive motor 220 at the timing corresponding to elapse of predetermined period T1 since control signal SE1 was turned ON.

In contrast, when standby flag FLG is turned ON after detection of control signal SE1 being turned ON, motor control unit 330 maintains control signal SE2 at an OFF state even after elapse of predetermined period T1 to delay driving motor 220. Subsequently, motor control unit 330 sets control signal SE2 on to start driving motor 220 in response to detecting standby flag FLG being turned OFF from determination unit 320.

The details of a starter drives control process executed at ECU 500 will be described with reference to the flowcharts of FIGS. 5-8. The flowcharts indicated in FIGS. 5-8 are realized by executing a program stored in advance in ECU 300 at a predetermined cycle. Alternatively, some of the steps may have the process realized by developing dedicated hardware (electronic circuit).

FIG. 5 is a flowchart representing the basic procedure of starter drive control executed at ECU 300 in the first embodiment.

Referring to FIGS. 4 and 5, ECU 300 causes pinion control unit 310 to execute a pinion drive control process at step (hereinafter, abbreviated as S) 100. At S200, ECU 300 causes determination unit 320 to execute a motor drive determination process. At S300, ECU 300 causes motor control unit 330 to execute a motor drive control process.

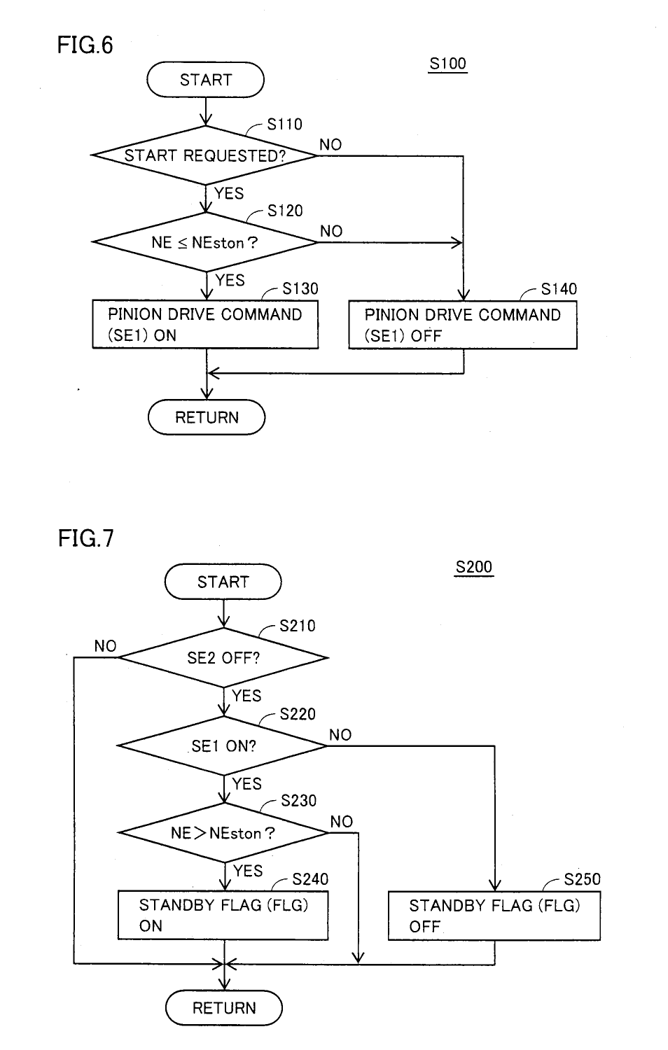

The details of the procedures in S100, S200 and S300 will be described hereinafter with reference to FIGS. 6, 7 and 8, respectively.

First, the details of a pinion drive control process will be described with reference to FIGS. 1 and 6.

At S110, ECU 300 determines whether or not a start request of engine 100 has been made.

When a start request is not made (NO, S110), control proceeds to S140 where ECU 300 maintains an OFF state of the pinion drive command, i.e. control signal SE1 directed to driving actuator 232.

When a start request is made (YES at S110), control proceeds to S120 where ECU 300 determines whether rotational speed NE of engine 100 is less than or equal to reference rotational speed NEston.

When rotational speed NE of engine 100 is greater than reference rotational speed NEston (NO at S120), control proceeds to S140 since the difference in speed between pinion gear 260 and ring gear 110 is so great that the possibility of not properly engaging is high. At S140, ECU 300 maintains control signal SE1 at an OFF state.

In contrast, when rotational speed NE of engine 100 is less than or equal to reference rotational speed NEston (YES at S120), control proceeds to S130 where ECU 300 sets control signal SE1 ON to drive actuator 232. Thus, engagement is established between pinion gear 260 and ring gear 110.

The details of a motor drive determination process will be described hereinafter with reference to FIGS. 1 and 7.

At S210, ECU 300 determines whether or not control signal SE2 of relay RY2 is OFF, i.e. whether or not motor 220 is driven.

When control signal SE2 is ON (NO at S210), i.e. when motor 220 is already driven, the subsequent processing is skipped, and control proceeds to S300 shown in FIG. 5.

When control signal SE2 is OFF (YES at S210), control proceeds to S220 where ECU 300 determines whether or not control signal SE1 is set at an ON state.

When control signal SE1 is OFF (NO at S220), control proceeds to S250 since an engagement operation of pinion gear 260 is not yet made. At S250, ECU 300 sets standby flag FLG OFF. Then, control proceeds to S300 (FIG. 5).

When control signal SE1 is ON (YES at S220), control proceeds to S230 where ECU 300 determines whether rotational speed NE of engine 100 is greater than reference rotational speed NEston.

When rotational speed NE of engine 100 is greater than reference rotational speed NEston (YES at S230), control proceeds to S240 where ECU 300 sets standby flag FLG ON. Then, control proceeds to S300 (FIG. 5).

When rotational speed NE of engine 100 is less than or equal to reference rotational speed NEston (NO at S230), the current state of standby flag FLG is maintained. This state corresponds to the period from time t10 to time t11, and from time t13 to time t14 in the case of line W12 shown in FIG. 3. In other words, this corresponds to the state where rotational speed NE of engine 100 is less than or equal to reference rotational speed NEston, and waiting for the elapse of a predetermined period.

Therefore, in the state from time t10 to time t11 of FIG. 3, standby flag FLG is not turned ON, and maintains an OFF state. During the period from time t13 to time t14, an ON state of standby flag FLG is maintained to delay the drive of motor 220.

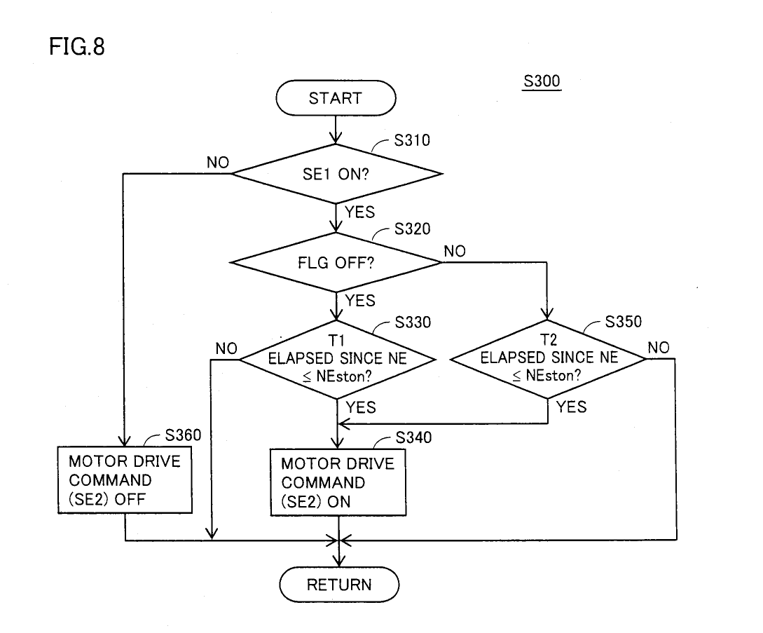

The details of a motor drive control process will be described with reference to FIGS. 1 and 8.

At S310, ECU 300 determines whether or not control signal SE1 is ON.

When control signal SE1 is OFF (NO at S310), control proceeds to S360 since actuator 232 is not yet driven. At S360, ECU 300 sets control signal SE2 that is a motor drive command at an OFF state.

When control signal SE1 is ON (YES at S310), control proceeds to S320 where ECU 300 determines whether or not standby flag FLG is OFF.

The state of standby flag FLG at an OFF state (YES at S320) corresponds to the state until predetermined period T1 has elapsed, from time t10 to time t12 in FIG. 3. Therefore, control proceeds to S330 where ECU 300 determines whether or not predetermined period T1 has elapsed.

When predetermined period T1 has not elapsed (NO at S330), control returns to the process of FIG. 5. If the state up to the current state has not changed, the process up to S330 is carried out again at the next control cycle. ECU 300 waits for the elapse of predetermined period T1.

The state of elapse of predetermined period T1 (YES at S330) corresponds to time t12 of line W11 in FIG. 3. Therefore, ECU 300 determines that engagement between pinion gear 260 and ring gear 110 has been established, and control proceeds to S340 where ECU 300 sets control signal SE2 ON to drive motor 220. Accordingly, engine 100 is cranked up to start engine 100.

The state where standby flag FLG is ON (NO at S320) corresponds to the state from time t11 to time t14 of line W12 in FIG. 3. ECU 300 proceeds to S350 where ECU 300 determines whether or not a predetermined period T2 has elapsed since rotational speed NE of engine 100 became less than or equal to reference rotational speed NEston.

When NO at S350, i.e. in a state where rotational speed NE of engine 100 exceeds reference rotational speed NEston (time t11 to time t13 of line W12 in FIG. 3), or when predetermined period T2 during which rotational speed NE of engine 100 is less than or equal to reference rotational speed NEston has not elapsed (time t13 to time t14 of line W12 in FIG. 3), ECU 300 maintains the current state and returns the control to FIG. 5 to wait for the elapse of predetermined period T2.

When predetermined period T2 has elapsed (YES at S350), control proceeds to S340 since this corresponds to the state of time t14 of line W12 in FIG. 3. At S340, ECU 300 sets control signal SE2 on to drive motor 220.

By the control according to the process set forth above, the pinion gear and ring gear can be engaged with each other appropriately in the event of an engine including a starter that can control individually a pinion gear and a motor for driving the pinion gear is to be restarted after being stopped, even in the case where variation in the engine rotational speed is great. Thus, the engine can be started reliably. Furthermore, the durability and quietness of the starter can be improved.

### Second Embodiment

In the first embodiment, reference rotational speed NEston defining the driving timing of the actuator was employed as the reference rotational speed for delaying the driving timing of the motor at the starter. Although employing a common reference rotational speed is advantageous in that control is rendered simple, the reference rotational speed for delaying the driving timing of the motor does not necessarily have to be equal to reference rotational speed NEston.

Reference rotational speed NEston defining the actuator driving timing is generally set taking into consideration the engine rotational speed that becomes lower during the operating time of the actuator itself. Therefore, there are cases where reference rotational speed NEston is set slightly higher than the engine rotational speed that allows actual engagement between the pinion gear and ring gear. However, it is preferable to reflect the engine rotational speed that allows actual engagement between the pinion gear and ring gear after the driving of the actuator is already initiated. To this end, the reference rotational speed defining the actuator driving timing is preferably set different from the reference rotational speed for delaying the motor driving timing.

The second embodiment is described based on a configuration in which determination as to whether or not the motor driving timing is to be delayed according to a reference rotational speed NEdly (second reference rotational speed) that is lower than the reference rotational speed NEston defining the actuator drive timing (first reference rotational speed).

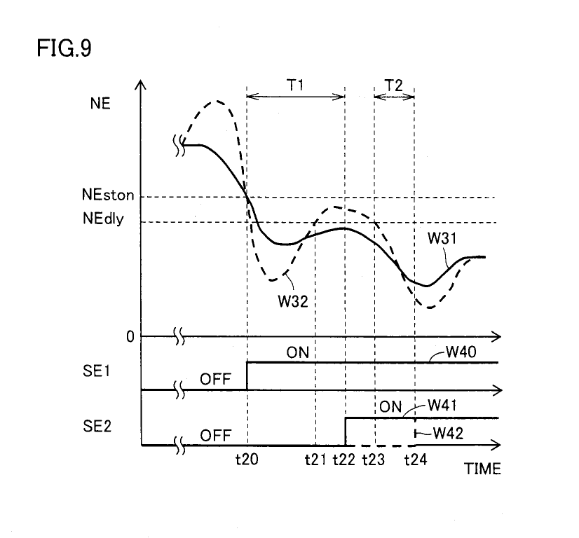

FIG. 9 is a diagram to describe the outline of starter drive control according to the second embodiment. Likewise with FIG. 3 corresponding to the first embodiment, the horizontal axis represents the time, whereas the vertical axis represents rotational speed NE of engine 100, as well as control signals SE1 and SE2 for driving actuator 232 and motor 220, respectively, in FIG. 9. Similarly in FIG. 9, lines W31 and W32 representing the state of engine rotational speed NE correspond to the state where an engine restart operation is not carried out.

Referring to FIGS. 1 and 9, reduction of engine rotational speed NE down to the level of reference rotational speed NEston after fuel supply to engine 100 has been stopped causes control signal SE1 to be turned ON at time t20 to initiate the driving of actuator 232 (line W40 in FIG. 9).

In the case where engine rotational speed NE does not exceed second reference rotational speed NEdly (NEdly<NEston) at time t20 and thereafter, as shown by line W31, control signal SE of relay RY2 to drive motor 220 is turned ON at time t22 corresponding to elapse of predetermined period T1 during which the engagement operation should be completed (line W41 is FIG. 9). Accordingly, engine 100 is cranked up.

In contrast, as shown in broken line W32, when the fluctuation variation is great and engine rotational speed NE exceeds second reference rotational speed NEdly prior to elapse of predetermined period T1 (time t21), driving of motor 220 at time t22 corresponding to the elapse of predetermined period T1 is prohibited. Then, at a point in time (time t24) corresponding to the elapse of predetermined period T2 since time t23 when engine rotational speed NE reaches second reference rotational speed NEdly again, as indicated by broken line W42 in FIG. 9, control signal SE2 of relay RY2 is set ON.

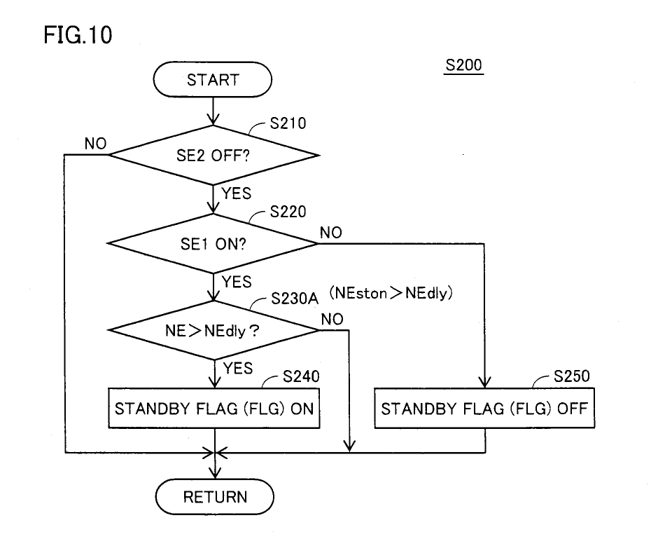

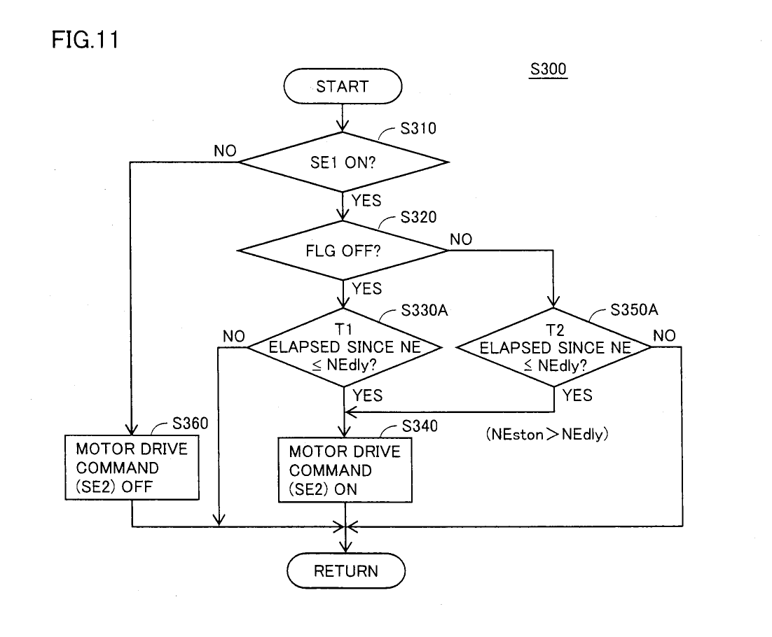

FIGS. 10 and 11 are flowcharts to describe a motor drive determination process and a motor drive control process, respectively, executed at ECU 300 in the second embodiment. FIGS. 10 and 11 correspond to the flowcharts of FIGS. 7 and 8, respectively, of the first embodiment. In the flowcharts of FIGS. 10 and 11, the condition for an ON state of standby flag FLG (S230A in FIG. 10) and the condition for an ON state of the motor drive command (S330A, S350A of S11) differ only in that second reference rotational speed NEdly is employed as the reference rotational speed for comparison. Therefore, other comparable steps of FIGS. 7 and 8 will not be repeated.

By setting the reference rotational speed for delaying the motor driving timing at a value differing from the reference rotational speed defining the actuator driving timing, a more smooth engagement between the pinion gear and ring gear can be established.

It should be understood that the embodiments disclosed herein are illustrative and non-restrictive in every respect. The scope of the present invention is defined by the terms of the claims, rather than the description of the embodiments set forth above, and is intended to include any modifications within the scope and meaning equivalent to the terms of the claims.

### REFERENCE SIGNS LIST

10 vehicle; 100 engine; 110 ring gear; 111 crankshaft; 115 rotational speed sensor; 120 battery; 125, 130 voltage sensor; 127 DC/DC converter; 140 accelerator pedal; 150 brake pedal; 200 starter; 210 plunger; 220 motor; 230 solenoid; 232 actuator; 240 coupling unit; 245 fulcrum; 250 output member; 260 pinion gear; 300 ECU; 310 pinion control unit; 320 determination unit; 330 motor control unit; RY1, RY2 relay

1. A control device for an engine provided with a starter including a second gear engageable with a first gear coupled to a crankshaft, an actuator moving said second gear to a position engaging with said first gear in a driving state, and a motor for rotating said second gear,
said actuator and said motor each being controllable individually,
said control device comprising:
a control unit driving said actuator when a rotational speed of said engine becomes lower than a predetermined first reference rotational speed, and driving said motor after said actuator is driven,
when the rotational speed of said engine exceeds a second reference rotational speed after said actuator is driven, said control unit delaying driving of said motor than when the rotational speed of said engine does not exceed said second reference rotational speed.

2. The control device for an engine according to claim 1, wherein, when the rotational speed of said engine exceeds said second reference rotational speed after said actuator is driven, said control unit delays driving of said motor until the rotational speed of said engine becomes lower than said second reference rotational speed again.

3. The control device for an engine according to claim 2, wherein
said control unit drives said motor when a first period has elapsed after said actuator is driven, and
when the rotational speed of said engine exceeds said second reference rotational speed after said actuator is driven and before said first period has elapsed, said control unit drives said motor when a second period has elapsed after the rotational speed of said engine becomes lower than said second reference rotational speed again.

4. The control device for an engine according to claim 3, wherein said second period is set shorter than said first period.

5. The control device for an engine according to claim 1, wherein said second reference rotational speed is set at a value equal to said first reference rotational speed.

6. The control device for an engine according to claim 1, wherein said second reference rotational speed is set at a value lower than said first reference rotational speed.

7. A starting device for an engine comprising:
said starter, and
the control device defined in claim 1.

8. A vehicle comprising:
an engine,
a starter including a second gear engageable with a first gear coupled to a crankshaft of said engine, an actuator moving said second gear to a position engaging with said first gear in a driving state, and a motor for rotating said second gear, and
a control device for controlling said starter such that said actuator is driven when a rotational speed of said engine becomes lower than a predetermined first reference rotational speed, and said motor is driven when a predetermined period has elapsed after said actuator is driven, and,
said actuator and said motor each being controllable individually, and
said control device, when the rotational speed of said engine exceeds a second reference rotational speed after said actuator is driven, delaying driving of said motor than when the rotational speed of said engine does not exceed said second reference rotational speed.

9. A starting device for an engine comprising:
said starter, and
the control device defined in claim 2.

10. A starting device for an engine comprising:
said starter, and
the control device defined in claim 3.

11. A starting device for an engine comprising:
said starter, and
the control device defined in claim 4.

12. A starting device for an engine comprising:
said starter, and
the control device defined in claim 5.

13. A starting device for an engine comprising:
said starter, and
the control device defined in claim 6.
